(19) United States
(12) Patent Application Publication
(10) Pub. No.: US 2016/0300223 A1
(43) Pub. Date: Oct. 13, 2016

(54) PROTECTED DATA TRANSFER ACROSS DISPARATE NETWORKS

(71) Applicant: Portable Data Corporation, Oakland, CA (US)

(72) Inventors: Victor Grey, Concord, CA (US); James Fournier, Nicasio, CA (US)

(21) Appl. No.: 14/681,953

(22) Filed: Apr. 8, 2015

(51) Int. Cl. G06Q 20/38; G06Q 20/40

(52) U.S. Cl. CPC G06Q 20/3825; G06Q 20/401; G06Q 20/3829; G06Q 20/3827; G06Q 2220/00

(57) ABSTRACT

An electronic marketplace system that protects data transfers across disparate servers or networks can include communication devices that couple system users to a mesh network of public key identity servers and/or link contract servers that are interconnected. The public key identity servers collectively contain a global last-closed ledger of public encryption keys for system users, and verify users using the public keys by accessing local ledgers or asking other identity servers for the public keys. A link contract server provides a link contract regarding the allowed use of the transferred protected data, and provides for a data transfer between the parties after all have agreed thereto. The link contract can be in JSON format in an HTTP or HTTPS header. Users can submit requests to link contract servers, and requests can be searched by vendors prior to proposing a link contract.

### TECHNICAL FIELD

The present disclosure relates generally to digital data transfer, and more particularly to protected digital data portability across multiple disparate networks and servers.

### BACKGROUND

Digital data sharing and transfers are ubiquitous in our modern computerized society. Many individuals, groups, companies, organizations, and the like routinely not only share digital data about themselves and things that they know, but also search for data and information about other parties and other things across closed networks, multiple networks, and the Internet. In general, data portability refers to the possibility for a user to have its data moved from one data host to another. Such a user can be an individual, company, or other party, and the user data can be moved by the user itself, or the user can grant permission to another party or entity to move or receive the data or ongoing currently updated copies of the data, such as by a link. Such data hosts can be on a single network, or can be across disparate networks and even the Internet in general. Such data can include data that has been self-created and/or data that has been created about the user as a result of its activities or other information storage.

Data portability can be important with respect to a user and/or a vendor or other party wishing to obtain or exchange identifying or other pertinent information, such as for a potential purchase or other commercial transaction or exchange. Of course, there can be many drawbacks to the unlimited availability and exchange of identifying or other personal information, and few people are willing to provide their own personal data in a wide open and unrestricted manner. There are almost always requirements, restrictions, or other protections that go along with providing such personal data, as is generally well known.

While the exchange of identifying or other personal data can often be kept under control or restricted when it takes place within a single controlled network or domain, it can be problematic to provide for data portability across multiple disparate servers, networks, or the Internet in general. For example, where a user might wish to obtain information about a particular product, he or she might provide his or her personal information or data on a proprietary website or single network of a known vendor for that type of product, where it might be reasonably expected that such information can be kept safe or protected by a reputable operator of the single website or network. Constantly and repeatedly providing personal information or data can be cumbersome and inefficient though, such as where a user might wish to provide and/or access data from multiple providers, networks, or sites.

In fact, it has become increasingly common simply to provide personal data over the Internet in general, sometimes in ways that are not well secured or protected. The Internet has become the common network connecting many other types of digital networks and devices for communications and data interchange. The increased use of the Internet has led to an increase in the number of applications and services running thereon, the number and value of transactions taking place, and the number and types of relationships that can be formed and maintained electronically. Each of these has in turn increased the importance of trust in online activities. Although a number of known technologies and services have been developed to meet this need, there tends to be drawbacks or limitations to each of that which is currently known.

For example, peer-to-peer reputation systems can be scalable, efficient, and do not require central trust authorities. Such systems, however, can be unduly complex, have not been robustly implemented, and can be vulnerable to outside attacks, particularly when the systems are distributed across multiple networks. Customer based networks can provide customer service and product feedback services across a large number of businesses, but these tend to be single networks. As such, they typically require every user to join in order to interact and build a large trusted community for that network. This also requires a user to create separate profiles and build up the corresponding reputations separately on each different profile and platform, which reputations typically are not transferable from one site or network to another.

Other types of systems or services similarly provide users and vendors with the ability to exchange protected information or data in a reasonably secure or protected manner. For example, banking and credit networks, as well as healthcare networks also have items and functions in place that serve to protect user information. As in the case of other systems, however, these also tend to involve proprietary or single networks, such that data portability across multiple disparate networks is just not possible for these data sets. When a given data sharing or portability system might be available across multiple networks, a user typically has little to no control over its own data once that data is released into the system. This can be problematic where the use of some sensitive data is necessary for the system to work, as few users will be willing to sign on to such an unprotected system.

While various systems and techniques for providing data portability have generally been adequate in the past, there is always a desire for improvement. To that end, it would be desirable to have improved data portability systems and techniques that are adapted for implementation across multiple disparate networks, and in particular for such systems and techniques to be more secure or protecting of the data of their users.

### SUMMARY

It is an advantage of the present disclosure to provide improved systems, methods, and techniques for transferring electronic data across multiple disparate servers and/or networks in a more protected manner. In particular, the improved systems and methods can allow users to set the terms for access controls and permissions to certain portions of their data according to automated rules prior to transferring the data. This can be accomplished at least in part by providing a specific data portability protocol that can be implemented on different servers that are distributed across disparate and unrelated servers or networks, such as over the Internet. In particular, the specialized protocol or portions thereof can reside on one or more link contract servers, and possibly also a plurality of public key identity servers, which can all communicate with each other. This collection of link contract server(s) and public key identity servers can operate collectively to verify user identities and to provide link contracts specifying terms of use for the electronic data prior to transferring the data.

In various embodiments of the present disclosure, an electronic marketplace system adapted to facilitate protected data transfers across disparate servers or networks can include one or more communication devices that are adapted to facilitate digital communications to system users, as well as one or more link contract servers that can be coupled thereto and to a plurality of separate public key identity servers. The one or more link contract servers can be adapted to provide a link contract to a requesting user and a responding user based upon preferences of either or both parties. The link contract server(s) can also be adapted to provide a protected data transfer between the requesting user and the responding user after both of the requesting user and the responding user have agreed to the link contract, such as by digitally signing the contract. The plurality of separate public key identity servers can be coupled to each other, can reside on separate and disparate servers or networks, and can collectively contain a global last-closed ledger of public encryption keys for users of said electronic marketplace system. Each of the separate public key identity servers can be adapted to verify using the public encryption keys the identities of the requesting user and the responding user as part of the protected data transfer.

In various detailed embodiments, the link contract can be communicated in an open standard format using human-readable text, such as, for example, JavaScript Object Notation (“JSON”). In addition, the link contract can be communicated by Hypertext Transfer Protocol (“HTTP”) or HTTP Secure (“HTTPS”), and may be contained in an HTTP or HTTPS header. Also, the plurality of public key identity servers can form a mesh network, and the protected data transfer can include personal data or other protected data regarding the responding user, the requesting user, or both. The link contract can include terms that restrict data usage, such as terms that restrict the requesting user as to the specific use of personal data regarding the responding user, for example. In various embodiments, a portion of a link contract can point to one or more third party locations that contain standard contract terms, contract portions, or entire contracts. Furthermore, the overall system can be adapted to provide searching, such as to be able to accept an inquiry from a user and provide that inquiry to other users of the system in a manner that is searchable with respect to other user inquiries. In addition, the system can adapted to provide link contract escrow services regarding the link contract.

The system can also be adapted to provide an index or various pointers to link contracts that are available on link contract servers or elsewhere, which can be done by content type, such as for personal data, and/or for particular music, video, or other media content for download under specific terms. In various embodiments, the system can also include one or more link contract index server portions, where such one or more link contract server portions can have links to contracts that are similar or concern similar data. In these or other embodiments, at least a portion of the link contract can point to one or more link contract index server portions or third party locations that contain standard contract terms, contract portions, or entire contracts. Also, the plurality of separate public key identity servers may or may not be included as part of the electronic marketplace system in various embodiments.

In various further embodiments of the present disclosure, one or more methods of protecting a data transfer between a user and a vendor on a system distributed across disparate servers or networks are provided. Such methods can include a variety of process steps, such as, for example, accepting an inquiry from a user, providing the user inquiry to a vendor, verifying the identities of the user and vendor, permitting either party to propose a link contract, accepting digital signatures from the user and vendor, and transferring the data. One, some, or all of these process steps can be automated, can include the use of a specific protocol, and can be performed over separate and disparate servers or networks. The user inquiry can be accepted at a link contract server, and can reflect interest regarding information for one or more products or services. The user inquiry can be provided to a vendor from the link contract server, wherein the vendor is able to provide one or more products or services relevant to the user inquiry. Identity verification can be performed by using a public encryption key for the vendor at a first public key identity server selected from a plurality of public key identity servers, and for the user by using a public encryption key for the user at the first public key identity server or a separate second public key identity server. The plurality of public key identity servers can collectively contain a global last-closed ledger of public encryption keys for system users, and can all be in communication with each other. The link contract can contain one or more terms regarding the specific use of the data that is to be transferred, and the digital signatures can indicate agreement by the signing parties with the terms of the link contract regarding the use of the data. The data can be transferred between the user and the vendor via the link contract server after the digital signatures have been accepted.

In various detailed embodiments, which can include the same or similar items or features from any of the foregoing embodiments, the link contract can be communicated between the user and the vendor in JSON, which can be done via an HTTP or HTTPS header. The data transfer can include personal data or other protected data regarding the user, and the link contract can include terms that restrict the vendor as to the specific use of the personal or other protected data regarding the user. Additional process steps can include, for example, creating a unique cryptographic hash of the link contract that is signed with or includes digital signatures of both the user and the vendor using their respective private keys, as well as providing a copy of the unique cryptographic hash and the digital signatures to both the user and the vendor as proof of the agreed upon link contract. Another process step can be allowing the vendor to search through a plurality of inquiries on the system, wherein the plurality of inquiries includes the user inquiry. Still further process steps can include searching the local ledger of public encryption keys for the public encryption key of the vendor at the first public key identity server, and then contacting one or more other servers from the plurality of public key identity servers for the public encryption key of the vendor in the event that the vendor key is not on the local ledger.

In still further embodiments, a computer readable medium including at least computer program code for protecting a data transfer between a user and a vendor on a system distributed across disparate systems and/or networks can include various portions of computer program code. This can include computer program code for accepting an inquiry from a user at a link contract server, computer program code for providing the user inquiry to a vendor from the link contract server, computer program code for verifying the identities of the vendor and user by using public encryption keys, computer program code for permitting the either the user or the vendor to propose a link contract to the other, computer program code for accepting digital signatures from both of the user and the vendor, and computer program code for transferring the data between the user and the vendor. Again, some or all of the foregoing details and features may similarly apply to that which is contained in the various portions of computer code. For example, the user inquiry can reflect an interest regarding information for one or more products or services, and the vendor can be able to provide the one or more products or services of interest. Verifying identifications can be by way of using a public encryption key at one or more public key identity servers selected from a plurality of public key identity servers that collectively contain a global last-closed ledger of public encryption keys for system users, and the link contract server and the public key identity servers are all in communication with each other. Either party can propose a link contract to the other from the link contract server in order to facilitate a data transfer between the user and the vendor. The link contract can contain one or more terms regarding the specific use of the data that is to be transferred. Digital signatures can indicate agreement with the terms of the link contract regarding the use of the data, and can be accepted at the link contract server. Also, the data can be transferred via the link contract server after the digital signatures have been accepted.

In various detailed embodiments, the data transfer can includes personal data or other protected data regarding the user, and wherein the link contract includes terms that restrict the vendor as to the specific use of the personal data or other protected data regarding the user. Also, the computer code can include code for creating a unique cryptographic hash of the link contract that is signed with or includes digital signatures of both the user and the vendor using their respective private keys, as well as code for providing a copy of the unique cryptographic hash and digital signatures to both the user and the vendor as proof of the agreed upon link contract. The computer program code can also include code for allowing the vendor to search through a plurality of inquiries on the system, wherein the plurality of inquiries includes the user inquiry.

Other apparatuses, methods, features and advantages of the disclosure will be or will become apparent to one with skill in the art upon examination of the following figures and detailed description. It is intended that all such additional systems, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed systems, methods, and techniques with respect to protected data transfers across disparate servers and networks. These drawings in no way limit any changes in form and detail that may be made to the disclosure by one skilled in the art without departing from the spirit and scope of the disclosure.

FIG. 1A illustrates in front perspective view an exemplary computing device suitable for use with an electronic marketplace system according to one embodiment of the present disclosure.

FIG. 1B illustrates in front perspective view an alternative exemplary computing device suitable for use with an electronic marketplace system according to one embodiment of the present disclosure.

FIG. 1C illustrates in front perspective view another alternative exemplary computing device suitable for use with an electronic marketplace system according to one embodiment of the present disclosure.

FIG. 2 illustrates in block diagram format an exemplary client or end user computing device or system suitable for use with an electronic marketplace system according to one embodiment of the present disclosure.

FIG. 3 illustrates in block diagram format an exemplary client system for a mobile device suitable for use with an electronic marketplace system according to one embodiment of the present disclosure.

FIG. 4 illustrates in block diagram format an exemplary electronic marketplace system adapted for providing protected data transfers thereacross according to one embodiment of the present disclosure.

FIG. 5 illustrates in block diagram format an exemplary linked data graph that can be used for an electronic marketplace system across disparate servers or networks according to one embodiment of the present disclosure.

FIG. 6 illustrates a flowchart of an exemplary method of protecting a data transfer on a system distributed across disparate servers or networks according to one embodiment of the present disclosure.

### DETAILED DESCRIPTION

Exemplary applications of apparatuses and methods according to the present disclosure are described in this section. These examples are being provided solely to add context and aid in the understanding of the disclosure. It will thus be apparent to one skilled in the art that the present disclosure may be practiced without some or all of these specific details. In other instances, well known process steps have not been described in detail in order to avoid unnecessarily obscuring the present disclosure. Other applications are possible, such that the following examples should not be taken as limiting.

In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

In various embodiments of the present disclosure, electronic marketplace systems and components thereof are provided to facilitate protected data transfers across disparate servers or networks that extend beyond the simple cases involving just a single server or network. In other embodiments, various methods are provided for protecting data transfers between users on systems distributed across disparate servers or networks. In still further embodiments, various computer readable mediums are provided for similarly protecting data transfers between users on systems distributed across disparate networks. While such embodiments are often characterized herein as between a user and vendor for goods or services, for example, it will be understood that such data transfers can also take place between any two parties in any form of business or personal relationship. Furthermore, while such embodiments are often characterized herein as involving the transfer of personal data or information, it will also understood that such data transfers can involve the use of any protected data or any other data at all between any two parties, and not just personal data.

In general, the transfer of data across disparate servers and/or networks can take place subject to an automated digital contractual process that is agreed upon between the parties exchanging data prior to the data being exchanged. In a general case, there can be a “requesting” party and a “responding” party with respect to the data that is to be exchanged. In some specific instances, one of these parties can be a “user” or customer, while the other is a “vendor” or provider. For example, a vendor or provider might be the requesting party with respect to the personal or other protected data of a user or customer that might be the responding party. Again, other types of parties and arrangements may also apply, such that any b2b or protected exchange of data between parties can be implicated. In such situations, either party could propose, or counter propose, a contract that would specify the terms under which the data would be exchanged. Such a contract can be a “link contract” that is a link within an electronic communication that is proposed, negotiated, and agreed upon electronically and in an automated and streamlined fashion between the parties. This link contract can then govern what either party is able to do with the information that is about to be exchanged. Under this approach, a given user can be much more empowered and in control of their own data prior to sending it or authorizing its release across the Internet in general or across other disparate networks.

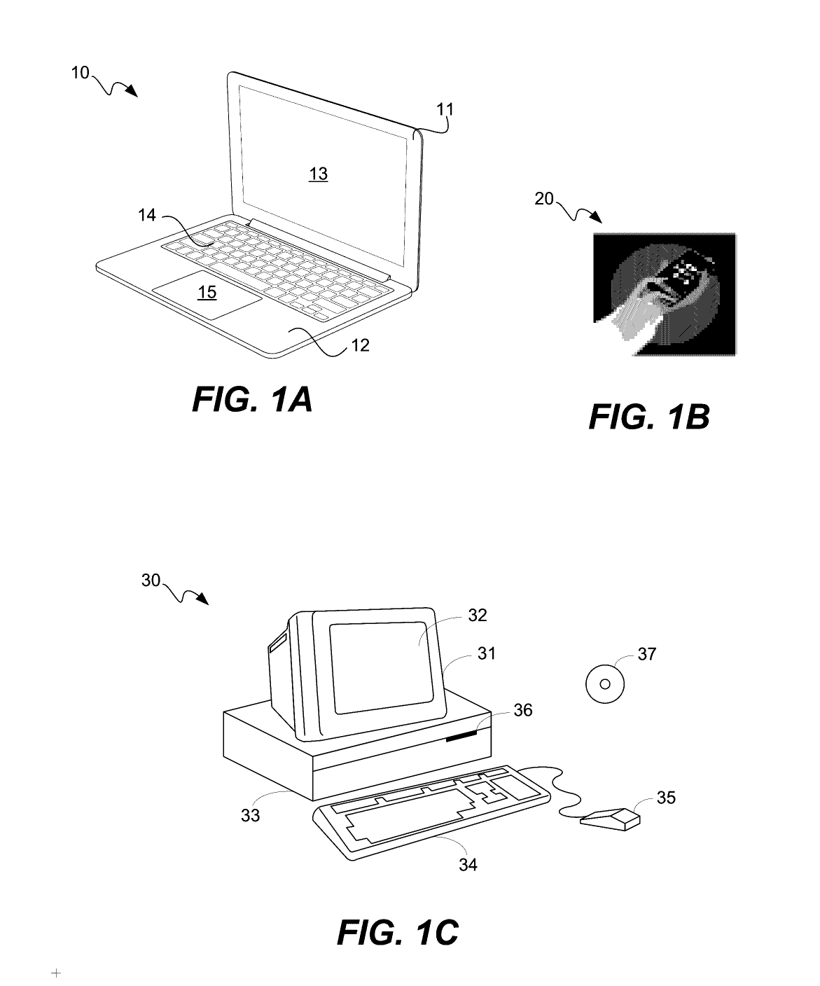

Referring first to FIG. 1A, an exemplary computing device suitable for use with the various electronic marketplace systems and methods therefor is shown in front perspective view. Computing device 10 can be a laptop computer, and can be particularly adapted to provide access to and functionality within an electronic marketplace system as provided herein. Such access and use could be for any user, customer, vendor, provider, individual, group, business, or other entity, as will be readily appreciated. It will be readily appreciated that computing device 10 can be provided in numerous other configurations and formats while still being able to provide the disclosed access and functionality with respect to an electronic marketplace system, such that the provided laptop example is for illustrative purposes only.

In general, computing device 10 can include an upper portion 11 and a lower portion 12. Upper portion 11 can include a display component 13 having a display region thereupon, while lower portion 12 can include various input devices, such as a keyboard 14 and touchpad 15. Lower portion 12 may also include a processor (not shown) therewithin, which can be adapted to process information regarding marketplace system activities, which can include data transfers, searching for information, providing information, proposing, negotiating, or authorizing link contracts, and the like. Such a processor can be coupled to the display component 13 and the input devices 14, 15, as well as other components of the computing device. Such other computing device components or items not shown may also be included, as will be readily appreciated, with such items including, for example, speakers, memories, busses, input ports, disk drives, power supplies, wireless interfaces, and the like.

FIG. 1B illustrates in front perspective view another alternative exemplary computing device that may also be used with the disclosed systems and methods. Smart phone 20 can similarly be used to provide access to and functionality within an electronic marketplace system as provided herein. As in the foregoing computing device 10, smart phone 20 can include at least a processor, display component having a display region, and one or more input devices, such as a touchscreen, button(s) and/or a keypad. In various embodiments, an electronic marketplace system can be provided as an application or “app” on an app store that can be accessed from smart phone 20. Such an app can be downloaded and then accessed or used on the phone 20.

FIG. 1C illustrates in front perspective view another exemplary computing device suitable for use with the disclosed embodiments. Computer system 30 can be, for example, a home or office computer system adapted to communicate over the Internet or other network. Such communication can also facilitate access to and functionality within an electronic marketplace system as provided herein. Computer 30 can include, for example, a display monitor 31 having a single or multi-screen display 32 (or multiple displays), a cabinet 33, a keyboard 34, and a mouse 35. The cabinet 33 houses a drive 36, such as for receiving a CD-ROM 37, a system memory and a mass storage device (e.g., hard drive or solid-state drive) (not shown) which may be utilized to store retrievable software programs incorporating computer code that implements the embodiment of the invention, data for use with embodiment(s) of the invention, and the like. Although the CD-ROM 37 is shown as an exemplary computer readable medium, other computer readable digital video including floppy disk, tape, flash memory, system memory, and hard drive may be utilized, as well be readily appreciated.

Although several examples of computing devices suitable for use with the disclosed electronic marketplace systems, methods, and other items have been provided in FIGS. 1A-1C, it will be readily appreciated that many other forms of electronic devices may also be suitable for such purposes. For example, electronic devices that may also be suitable can also include a system server, tablet computer, personal digital assistant, or the like, among other possible items.

According to different embodiments, various different types of encryption/decryption techniques may be used to facilitate secure communications between devices within an electronic marketplace system and/or across other networks. Examples of the various types of security techniques which may be used may include, but are not limited to, one or more of the following (or combinations thereof): random number generators, SHA-1 (Secured Hashing Algorithm), MD2, MD5, DES (Digital Encryption Standard), 3DES (Triple DES), RC4 (Rivest Cipher), ARC4 (related to RC4), TKIP (Temporal Key Integrity Protocol, uses RC4), AES (Advanced Encryption Standard), RSA, DSA, DH, NTRU, and ECC (elliptic curve cryptography), PKA (Private Key Authentication), Device-Unique Secret Key and other cryptographic key data, SSL, quantum-entangled data, etc. Other security features contemplated may include use of well-known hardware-based and/or software-based security components, and/or any other known or yet to be devised security and/or hardware and encryption/decryption processes implemented in hardware and/or software. Software, hardware and/or software+hardware hybrid embodiments of the various electronic marketplace systems, methods, and techniques described herein may be implemented on a general-purpose programmable machine selectively activated or reconfigured by a computer program stored in memory. Such programmable machine may include, for example, mobile or handheld computing systems, PDA, smart phones, notebook computers, tablets, netbooks, desktop computing systems, server systems, cloud computing systems, network devices, and the like.

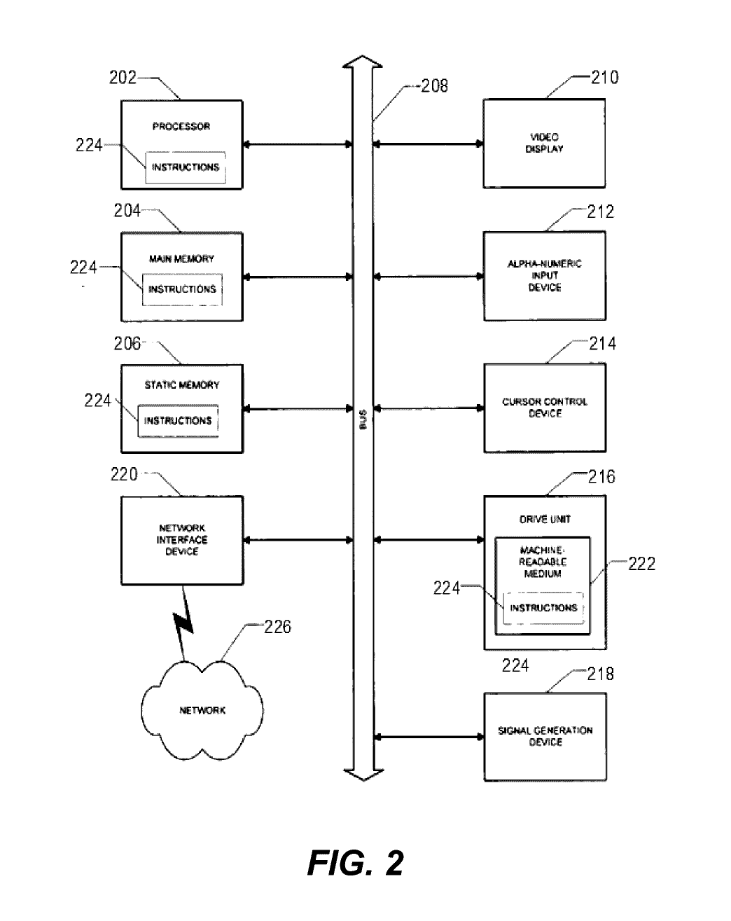

Turning next to FIG. 2, an exemplary client or end user computing device or system suitable for use with an electronic marketplace system according to one embodiment of the present disclosure is illustrated in block diagram format. Computing device or system 200 can be identical or similar to any of the foregoing computer devices 10, 20, 30, as well as any other suitable computing device, system, or component that may adapted for providing access and functionality within any of the disclosed electronic marketplace systems and/or methods or other embodiments.

Computing device or system 200 may contain a set of instructions for causing itself or another networked machine to perform any one or more of the methodologies discussed herein. As such, computing device or system 200 may operate as a standalone device or machine, or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Exemplary computer device or system 200 includes a processor 202 (e.g., a central processing unit (CPU), a graphics processing unit (GPU) or both), a main memory 204 and a static memory 206, which communicate with each other via a bus 208. The computer device or system 200 may further include a video display unit 210 (e.g., a liquid crystal display (LCD) or a cathode ray tube (CRT)), and also an alphanumeric input device 212 (e.g., a keyboard), a user interface (UI) navigation device 214 (e.g., a mouse), a disk drive unit 216, a signal generation device 218 (e.g., a speaker) and a network interface device 220. The disk drive unit 216 includes a machine-readable medium 222 on which is stored one or more sets of instructions and data structures (e.g., software 224) embodying or utilized by any one or more of the methodologies or functions described herein. The software 224 may also reside, completely or at least partially, within the main memory 204 and/or within the processor 202 during execution thereof by the computer device or system 200, wherein the main memory 204 and/or the processor 202 may also be constituting machine-readable media.

The software 224 may further be transmitted or received over a network 226 via the network interface device 220 utilizing any one of a number of well-known transfer protocols (e.g., HTTP, HTTPS). While the machine-readable medium 222 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

According to various embodiments, computing device or system 200 may include a variety of components, modules and/or systems for providing various types of functionality. For example, in at least one embodiment, device or system 200 may include a web browser application which is operable to process, execute, and/or support the use of scripts (e.g., JavaScript, AJAX, etc.), Plug-ins, executable code, virtual machines, HTML5 vector-based web animation (e.g., Adobe Flash), etc. In at least one embodiment, the web browser application may be configured or designed to instantiate components and/or objects at the device or system 200 in response to processing scripts, instructions, and/or other information received from a remote server such as a web server. Examples of such components and/or objects may include, but are not limited to, UI components, database components, processing components, and other components that may facilitate and/or enable device or system 200 to perform and/or initiate various types of operations, activities, and functions, such as those described herein with respect to accessing and functioning within an electronic marketplace system.

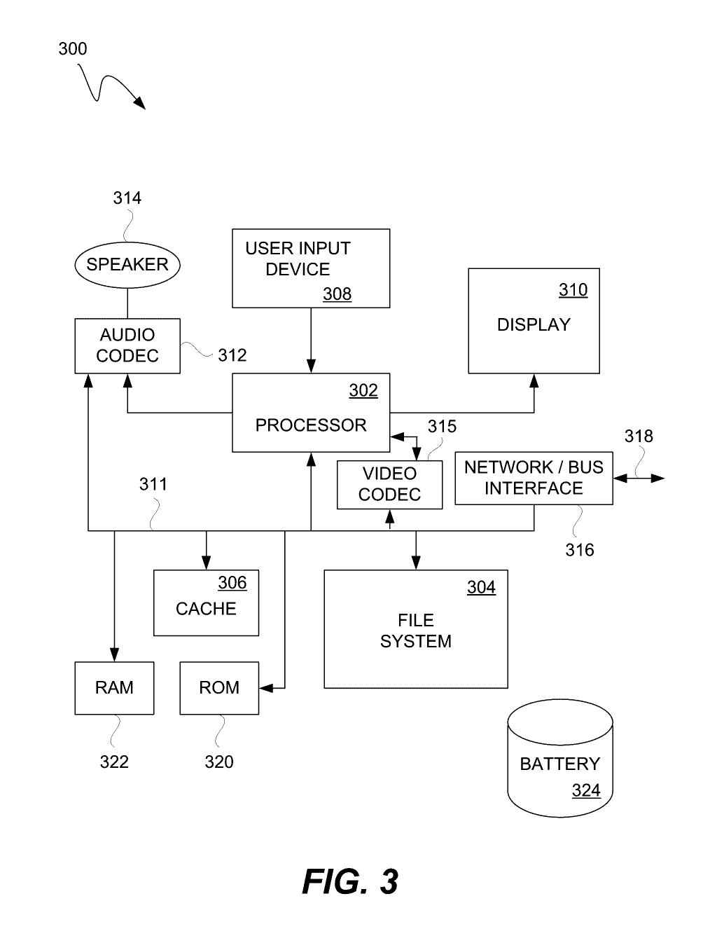

Continuing with FIG. 3, a block diagram of an exemplary client system for a mobile device suitable for use with an electronic marketplace system is provided. Mobile device 300 can be, for example, a smart phone, portable media player, personal digital assistant, tablet computer, laptop computer, or any other electronic device suitable for running applications that can include access to and functionality within an electronic marketplace. Although device 300 depicts circuitry of a representative portable electronic device, it will be readily understood that some elements may be omitted and others may be added in other electronic devices that may be suitable to function in a similar manner. In at least one embodiment, the mobile device client system 300 may include an Electronic Marketplace Mobile Device App Component, which has been configured or designed to provide functionality for enabling or implementing at least a portion of the various electronic marketplace functions and techniques at the mobile device client system. Such a mobile device app component can be provided for download by a service provider, such as an app store for smart phone devices.

Portable electronic device 300 can include a processor 302 that pertains to a microprocessor or controller for controlling the overall operation of the device. Device 300 can store data pertaining to various applications, programs, functions, and transaction histories in a file system 304 and a cache 306. The file system 304 can include semiconductor memory (e.g., Flash memory) and/or one or more storage disks. File system 304 can provides high capacity storage capability for the device 300, while cache 406 can provide low capacity but high speed storage capability, as will be readily appreciated. The cache 306 is, for example, Random-Access Memory (RAM) provided by semiconductor memory. Device 300 can be powered by a battery 324, which may be rechargeable. Device 300 can also include a RAM 320 and a Read-Only Memory (ROM) 432. The ROM 322 can store programs, utilities or processes to be executed in a non-volatile manner. The RAM 320 provides volatile data storage, such as for the cache 306.

Device 300 can also include one or more user input devices 308 that allows a user of the device to interact with the device. For example, the user input device(s) 308 can take a variety of forms, such as a button, keypad, dial, touch-sensitive surface, and the like. Still further, the electronic device 300 can include a screen display 310 that can be controlled by the processor 302 to display information to the user. A data bus 311 can facilitate data transfer between at least the file system 304, the cache 306, the processor 302, an audio coder/decoder (CODEC) 312 and/or a video CODEC 315, among other components. Electronic device 300 can also include a network/bus interface 316 that couples to a data link 318 or other communication device or interface. The data link 318 allows the device 300 to couple to or otherwise communicate with another device or over a network. The data link 318 can be provided over a wired connection or a wireless connection. In the case of a wireless connection, the network/bus interface 316 can include a wireless transceiver. In some embodiments, the data link 318 can also provide power to the device 300 (e.g., to charge the battery 324).

It will be readily appreciated that each of the foregoing computing devices and systems can be used by any user, vendor, or other party in conjunction with protected data transfers over disparate servers and/or networks, such as the Internet in general, as provided herein. In effect, these devices and system can function as end points for various parties accessing an overall electronic marketplace system where such protected data transfers can take place. Access control and restrictions for such protected data transfers is ideally achieved by users at these end points. In particular, data sharing between separate parties or entities over the Internet or other disparate networks can utilize a new “consent management layer” as provided herein.

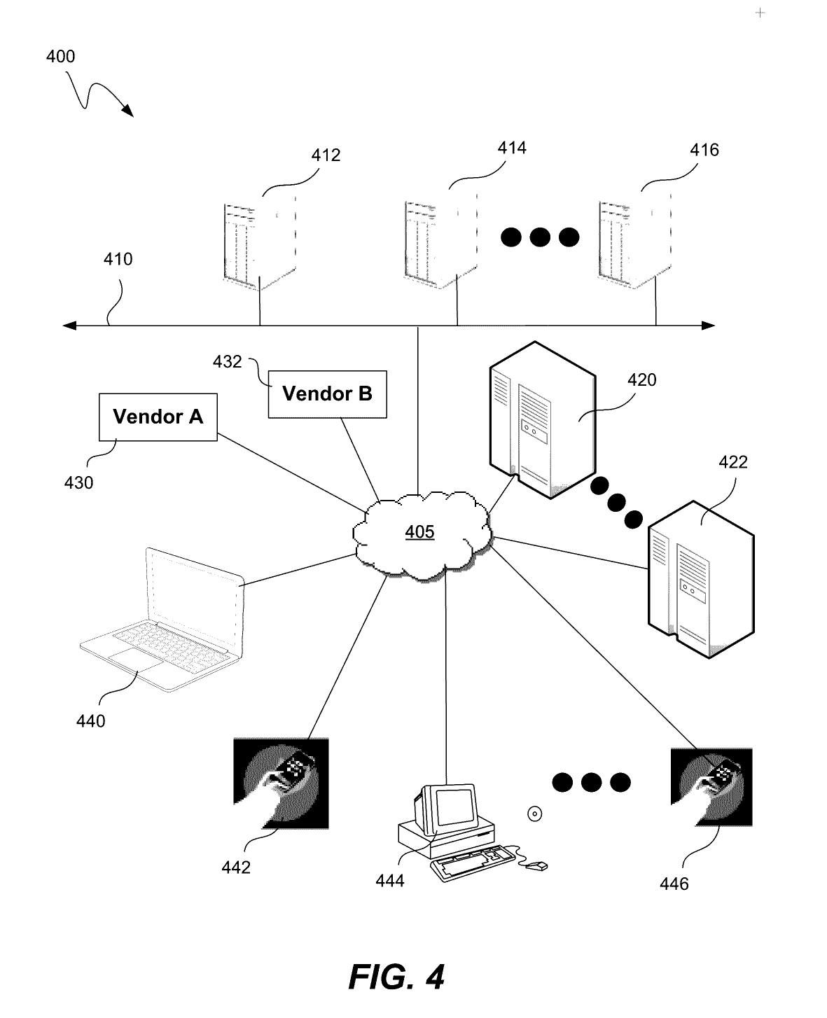

Turning next to FIG. 4, an exemplary electronic marketplace system adapted for providing protected data transfers thereacross is presented in block diagram format. Wide area electronic marketplace system 400 can include a variety of components and items, starting with at least one or more link contract servers 420, 422, each of which can include or be coupled to one or more communication devices adapted to facilitate digital communications over the Internet 405 or other network entity to various system users. Other components that can be part of an electronic marketplace system 400 or greater distributed network can include a plurality of public key identity servers 412, 414, 416, which can be interconnected such as on a mesh network 410 that is coupled to an overall cloud or network 405, such as the Internet. It will be readily appreciated that many more servers than the three shown public key identity servers 412, 414, 416 and the two shown link contract servers 420, 422 can be provided in a typical electronic market place system, and that there may in fact be dozens, hundreds, thousands, or more of each type of server. Various aspects and functions for these public key identity servers 412, 414, 416 and these link contract servers 420, 422 are provided in greater detail below.

In addition to the various servers set forth above, electronic marketplace system can also include various users or members, such as one or more vendors 430, 432, and also one or more users 440, 442, 444, 446, which can all be interconnected via an overall cloud or network 405, such as the Internet. Again, there may be many more than just two vendors or providers 430, 432, as well as many more than just four users or customers 440, 442, 444, 446. Each of these vendors, users, and/or other parties can use any of the foregoing computing devices and/or other components for access and operability within the overall system 400, as will be readily appreciated. In addition to the various items shown for electronic marketplace system 400, there may also exist further items or resources, such as a separate central database, contract repository, contract escrow server, link contract type index server or server portion, contract aggregation server (all not shown), and so forth, as may be desired. Alternatively, or in addition, such items, functions, or server elements may be contained on one or more of the link contract servers 420, 422, which link contract servers, their specific functions, and their ability to interact with the other system components provide a substantial basis for overall system 400. In short, link contract servers 420, 422 provide key functionalities and protocols with respect to the ability to have secure data transfers or portability across network or Internet 405.

Other efforts to provide for data transfers or exchanges across networks in a similar context can be found at, for example, U.S. Patent Publication No. 2012/0290427 to Reed, et al. (“Reed”). As shown by Reed, a “trusted” network of clients and servers can cooperate to maintain a logical graph of information describing the relationships between members of the network, the data associated with each member, and the permissions each member grants to other members to access and operate on the data and relationships described in the logical graph. This logical graph may be represented and serialized using many different data structures and serialization formats. Open standard formats can be used for interoperability, such as the XML format (as defined by the World Wide Web Consortium in XML 1.1 (Second Edition) and XML Schemas 1.1) the JSON format (as defined by the Internet Engineering Task Force in RFC 4627), the RDF format (Resource Description Framework, as defined by the World Wide Web Consortium), and the XDI format (as defined by the XRI Data Interchange (XDI) Technical Committee at the Organization for the Advancement of Structured Information Standards (OASIS)), among others. Various other details and examples regarding the implementation and use of such open standard formats can be found throughout Reed, which is incorporated herein by reference for such purposes.

As provided by the various embodiments disclosed herein, trusted automated data transfers or exchanges can alternatively result from an enforceable, legally binding, machine readable, and relatively simple protocol for managing dynamically updated permissions to granular data across the Internet or other disparate servers or networks. In order to achieve such results, again various forms of link contracts can be implemented between parties that are to transfer or exchange such data, which can take place on, for example, one or more link contract servers 420, 422. The use of such link contracts can ultimately allow a wider variety of more protected transactions involving the exchange or portability of data. For example, an improved customer “intention-casting” can replace general or even targeted advertising with a permission-based data exchange. Other types of business-to-business data transfers or exchanges can also be subject to such automated, simple, yet legally binding link contracts. In addition to allowing for improved intention-casting, and more secure data portability or transfers, improved vendor or social search abilities that respect the stated desires of the targets of the search for the use of their data can be obtained through the use of link contracts.

In general, intention-casting describes an environment where a user can express interest in a particular type of product, service or activity, and vendors who would like to serve that interest can contact the user in a way that does not undermine the privacy and control of the user over its own personal data or other protected data in general. For a user or customer this provides a way to view offers or advertisements only for things of actual expressed interest, as well as the ability turn off the flow of such information once a purchase is complete or there is otherwise no longer interest. For a vendor or provider such intention-casting provides a channel to customer attention that is far more efficient and potentially effective than general or even “targeted” advertising, as well as to establish positive relationships with customers rather than annoying them with unwanted advertising bombardment. Such intention-casting can also open up the opportunity to display for vendors a real-time view of a more accurate moment to moment state of the market for their offerings.

As noted above, data portability generally refers to the possibility for users to move the data that they have created about themselves, or that has been created about them as a result of their activities, from one online data host to another. Greater security or protections in such data portability of personal information, or for data transfers of other protected information or any other information in general, can be had by way of link contracts that specifically restrict or otherwise proscribe what other parties can and cannot do with the data being transferred.

Vendor or social search refers to the capability for a vendor, provider, or other user or party to enter search terms into a system or an application thereof and discover information about and communication channels with customers and other users matching the entered search terms. Such searching abilities can be categorized, indexed, stored, and made available according to various categories, which can include the desired products or services, as well as the terms under which a given user is willing to release his or her protected information. Vendors or other users who are inclined to search for customers or other users by way of desired products or services can also then be permitted to search by way of what such customers or users are willing to allow with their information.

The current state of the art generally allows for a reasonable level of intention-casting, secure data portability, and search capabilities within a single network, and such offerings tend to be mostly an all or nothing proposition. In some such applications, a user still loses any control over what is done with his or her protected information once it is shared. Attaining all of these items over the Internet or over disparate networks in general is not currently available in the prior state of the art, at least with respect to secure and controlled data portability.

In contrast, the presently disclosed embodiments provide for improved intention-casting, data portability and respectful social search over the Internet or other disparate servers or networks. This can be accomplished by providing a protocol that includes a suitable data graph element, a link contract element, and an identity layer element that all work in tandem with each other. A working title for this new protocol can be, for example, “JLINC” (JSON-LD LINk Contract).

For the data graph element, it would be preferable to use a suitable open standard format, such as one that utilized human-readable text, for example. Such an open standard format can be in the form of JavaScript Object Notation (“JSON”), and in particular JSON for Linking Data (“JSON-LD”). It is specifically contemplated that the JSON-LD standard (see, e.g., http://www.w3.org/TR/json-ld and http://json-ld.org) can be particularly useful for purposes of the present embodiments, although any standard format that can be used across many disparate platforms and networks might also be suitable for such data graph purposes. In particular, JSON-LD documents are completely standards compliant for most all applications, and are therefore readable, parseable, and writable by all of the many JSON libraries. In fact, it is believed that every modern language used for web development has a JSON library. JSON-LD is also backwards compliant with the RDF standard, such that any RDF document can be expressed in JSON-LD and vice-versa.

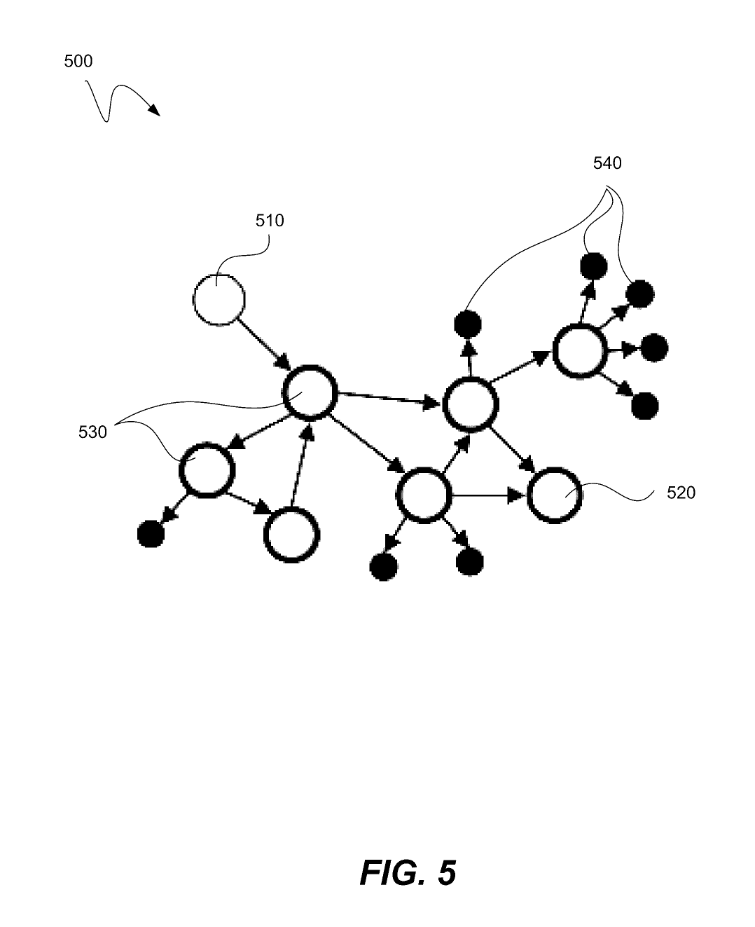

FIG. 5 illustrates in block diagram format an exemplary linked data graph that can be used for an electronic marketplace system across disparate servers or networks according to one embodiment of the present disclosure. Linked data graph 500 can be in JSON-LD format, for example, and can include various nodes, such as subject 510, object 520, subject/objects 530, and a plurality of values 540. Various nodes in graph 500 can be called subjects or objects, while edges are called properties. A subject 510, 530 is a node with at least one outgoing edge whereas an object 520, 530 is a node with at least one incoming edge. Thus, a node can be a subject and an object 530 at the same time. Although a subject should be labeled with an Internationalized Resource Identifier (“IRI”), JSON-LD also supports unlabeled nodes. Even though such nodes do not fulfill the requirements of Linked Data, they are supported as they allow certain use cases which require just locally referenceable data. The same applies to properties or edges, in that if they are labeled with an IRI then they are referenceable from other documents and are thus Linked Data. Otherwise they are just traditional JSON properties that only have a meaning in the specific document where they are used.

This kind of flexibility in a JSON-LD linked data graph renders this particular standard as being very suitable for purposes of the presently disclosed embodiments and their ability to operate across most all networks, systems and architectures. In general, JSON objects are collections of key/value pairs, and JSON-LD extends JSON simply by creating some standard keys. The two most important of these are @id and @context. These can be understood as type signifiers—the @id key indicates that its corresponding value is an IRI, while the @context key has a value that can be either an IRI reference or an included object. These particular properties can provide an excellent way in which to create link contracts on a link contract server, as set forth below.

For the link contract element, various link contracts can be provided or created for, by, and between users, vendors, and various other parties on an electronic marketplace system. Such link contracts can be provided, accessed, offered, negotiated, agreed to, and otherwise used on one or more link contract servers on the system, such as link contract servers 420, 422 above. Again, dozens or hundreds of link contract servers may be present on an overall system, each of which may have partial or full functionality, as well as one or more other functions or aspects that may be in addition to link contract server abilities. In various embodiments, different users, parties, or entities may operate different link contract servers on the same overall system. It is specifically contemplated that each such party that may operate one or more link contract servers can be operating its own electronic marketplace system as its own system or a subset of a greater electronic marketplace system having additional link contract servers and/or other components.

In general, link contracts can be provided between two parties on the overall system prior to an exchange or porting of data between the parties or from one party to the other. As one general non-limiting example, a user or customer may desire to provide personal information or other protected information to a potential vendor or provider. Such personal information can include the user name, gender, age, address, phone number, credit card number, social media account(s), transaction histories, online reputation, relationships with other users and vendors, and/or other informational items, for example. Again, other information can also be transferred or exchanged, and it will be readily understood that the present subject matter can be applied to all such information.

The user may wish to limit or restrict how the vendor will use this information, and as such can make sure that the appropriate terms restricting use of the data are in place in a digitally signed linked contract prior to allowing or authorizing the transfer or porting of this information. Such restrictions can include, for example, that the information can be used only by the vendor and/or other specified parties associated with the vendor, that the information can only be used in order to formulate a specific offer to the user, or to reference or properly identify the user, and/or that the information may only be used for the next hour, day, week, or other time period, for example. Other terms or restrictions on the use of the data may also apply.

These and other terms as may be appropriate can be put into a link contract that then binds the user and the vendor, or other parties prior to a data transfer, as may be appropriate. Such terms may be contained in standard link contracts or portions thereof, which can be readily accessible and used by the user and/or vendor in order to make a specific link contract for a specifically contemplated upcoming data transfer. These contract terms can be contained on one or more link contract servers 420, 422, and/or may be located elsewhere on line. Such remotely located places for contact terms can either be referenced, such as by pointers within a given link contract, or can be accessed for full copy and paste functionality into a given link contract. In various embodiments, there may be one or more databases or repositories for such link contract terms, provisions, portions, and full contracts.

This ability to formulate link contracts for various marketplace purposes may be accomplished in a fully or partially automated manner in various embodiments. For example, where a typical user may submit an inquiry for information regarding cars or tires online, there may be one or more standard link contracts for vendors in these fields which can then pop up and be offered to the user. Alternatively, or in addition, one or more repeat users of the system may prefer their own link contracts when they go onto the system to look for or inquire about one or more goods or services. In instances where a user and a vendor each propose their own stock or standard link contract to each other, then some amount of negotiation and changes may need to be made prior to arriving at a final link contract to be signed by both. In some situations, an artificial intelligence or other aspect may assist in proposing one or more compromises or alternative terms, so as to streamline the contract formation process. For example, where a user proposes his or her own standard link contract that restricts the use of his or her data to the next day, but a car company has its own standard link contract that asks for a 2 week period to use the data, the system may propose a one week period.

In various embodiments, the system can include one or more link contract index server portions, which can be contained on one or more of the link contract servers themselves, and/or may be contained at one or more third party locations. Such link contract server portions can contain actual contracts and/or links to contracts that are similar or concern similar data with respect to a current link contract of interest that is being formulated and/or finished. In such embodiments, at least a portion of the link contract can point to one or more link contract index server portions or third party locations that contain standard contract terms, contract portions, or entire contracts, for example. Such items can be used as a starting point for creating a new link contract in an automated manner, and/or can be used as a linked reference for a finished link contract.

With respect to the actual link contract itself, this item can be provided in JSON-LD format, and may be communicated over HTTP and/or HTTPS, such as in an HTTP or HTTPS header. As such, the link contract is very likely to be communicated to each party and across all networks and servers in a manner that is readable regardless of the various languages and protocols used by each party and any other entity in between. For the link contract, an @context link-contract object can define all the link contract terms, which could include pointers to other documents (e.g., EU regulations), and can be included in the data graph either copied in whole, or just with an IRI pointer, for example.

In various embodiments, a vendor, provider, or other party wishing to request data about another user (i.e., a “requesting user”) could first issue an “OPTIONS” request, which is a standard HTTP call commonly used in the websockets protocol, for example. Such an OPTIONS request could be asking for link contract information. A user, customer, or other party wishing to respond to this request for data (i.e., a “responding party”) could then respond to the OPTIONS request via a suitable link contract server with a JSON-LD document representing an appropriate link contract as requested. If there is agreement, then the user could digitally sign the link contract and include it in the header of a regular GET request. The vendor could sign the link contract as well. If authorization is proper, then the link contract server could record the signed link contract and deliver the requested data to the vendor. Other details are also possible for such a transaction, as provided elsewhere herein.

Various embodiments can include one or more ways to communicate these link contracts back and forth, such as, for example, via HTTP headers. One useful standard for that can be by way of a JSON Web Token (“JWT”), which provides a “compact, URL-safe means” to send signed JSON documents over the Internet or other disparate networks (see, e.g., https://tools.ietf.org/html/draft-ietf-oauth-json-web-token-30). Such a JWT can use, for example, a message authentication code (“MAC”) to ensure that a given payload has not been tampered with, or an asymmetric key for identification and non-repudiation, such as to prove that a party agreed to the link contract. In various embodiments of the present disclosure, a JWT having an MAC can be used as a means for including a given link contract with an OPTIONS response header, thus ensuring that the link contract that is returned is the exact one that was sent. The ensuing GET request can include the JWT, now signed by the other party, which can then be used to record and prove agreement.

For the identity layer element, a plurality of public key identity servers 412, 414, 416 can be used. In various embodiments, each user identity can be globally unique, the identity layer can be as decentralized as possible, and the identity verification process can be easy for users to manage and share. In various embodiments, a public/private encryption key system can be used for each user identity. The plurality of public key identity servers, which again can form a mesh network, can also include the public key part (i.e., asymmetric key) of such a public/private key pair for each user. As such, each user identity can be its public key, since the ability to prove possession of the corresponding private key by providing a cryptographically valid signature is the way that identities can interact for authentications and link contract exchanges. In other words, a public key is the root of the data graph for each system user.

In various arrangements, blockchains can be used for the purpose of registering identities and associating them with a public key. Blockchains have a number of attractive properties, including being mathematically provably secure, global in scope, and no requirements for any central authority. There are drawbacks to blockchains, however, including a relatively slow overall process and a need for volunteers on the network to do proof of work calculations in a competitive manner.

In various embodiments, a last closed ledger protocol for a mesh network of public key identity servers can be used. In such arrangements, each user can transact on the system through one trusted node, and that node in turn has a set of nodes that it also trusts. This can result in a relatively small subset of all the nodes in a global system that can grow to any size. This can be substantially similar to a “Ripple protocol,” which can arrive at a mathematically provable consensus in a very short time, such as on the order of one second or less (see, e.g., https://ripple.com/files/ripple_consensus_whitepapter.pdf). Such a Ripple protocol generates a global append-only ledger with respect to financial transactions, which can also be an abstract definition of a blockchain. This can be termed a “last closed ledger,” and this specific Ripple protocol and its implementing technology is currently freely available under a permissive open source license.

In various embodiments, a similar protocol to the foregoing can be applied to transactions that register and make findable public keys representing user identities rather than financial transactions. Unlike the “certificate authority” system that is generally used for SSL protected websites, this approach results in no potentially corruptible central authority. This is due to the globally distributed nature of a mesh network across many public key identity servers, which does not have a complex hierarchy of trusted signatures that make for such poor usability in the PGP system. Because the present last closed ledger for finding public keys uses an append-only ledger, revoking compromised keys only requires adding a new entry into the ledger. Each system server ledger can be searched from the leading edge backwards, such that the most recent key for any identity will always be found first (with links back to previous keys for accurate history).

Using this last closed ledger protocol or approach across all of the public key identity servers, these servers can then form a mesh network. As such, any identity on the entire system can be looked up by a user on any one of the identity servers in the network, such as, for example, whichever server is closest or most efficient for the user. In the event that the public key that is desired is not on the local or currently used identity server, then a request is sent from that server across the mesh network of identity servers for that particular public key. Each identity server getting that request can then search its own local ledger from the leading edge backwards. Upon finding the public key at issue, another server can then communicate that key to the currently used identity server for use in a particular transaction. Such public keys can also be communicated to one or more link contract servers, as may be appropriate for some embodiments.

In summary then, the present disclosure contemplates an electronic marketplace system that utilizes: (1) a specific JLINC protocol or other open source protocol, and (2) a network of JLINC servers, which can include one or more link contract transaction servers as well as a plurality of public key identity servers. An exemplary transaction on the overall system can involve two parties looking up the public keys of each other on the JLINC identity server mesh network, and also using the JLINC protocol and the network of JLINC servers to agree to and digitally sign a link contract prior to transferring, porting, or otherwise transmitting requested data therebetween.

Such a system allows for a more protected moving or porting of user data from one network or server to another. This can be done in order to make known to vendors, providers, and/or other system users the possible purchase interests, desires, or other inquiries of a given user in a way that does not compromise the control of their own protected data for a given user. This also can be done while still assuring the vendor or other provider that the user is a qualified customer, and permitting the vendor to contact the user with more relevant information and offers. Finally, this can also allow the user to withdraw from being contactable or having his or her data used when he or she is no longer interested.

In various embodiments, the overall system also allows for search abilities for other users across disparate social networks, without compromising the control of data for each user thereon. Such search capabilities may be contained on one or more link contract servers, and/or on one or more other system servers, such as a centralized informational or search friendly server.

In various embodiments, one or more link contract servers and/or one or more third party providers may allow for the copying, provision, or other use of standard link contracts. Such contracts can be provided to one or more link contract servers upon request, and/or can be kept at a third party provider server or website. Such third party providers may also provide a recording or repository service as an added benefit to users, vendors or other individuals who may desired added security or referencing abilities with respect to signed link contracts.

In various embodiments, one or more link contract servers and/or one or more third party providers may allow for financial or informational escrow with respect to various signed link contracts. As such, funds or information can be held by an escrow provider and then forwarded or transferred once other agreed upon conditions have been later fulfilled. Such provisions may also be part of a link contract, and a third party can be qualified as a neutral party to determine or verify when such additional conditions have been met prior to releasing the subject funds or information.

In various embodiments, one or more link contract servers and/or one or more third party providers may allow for the sale or provision of digital content in association with the link contract and associated provisions. Such items might include, for example, music, videos, movies, or other digital content, which may include indexes for same. Such indexes might also include a standardized transaction service, which could take the place of a conventional search in various embodiments.

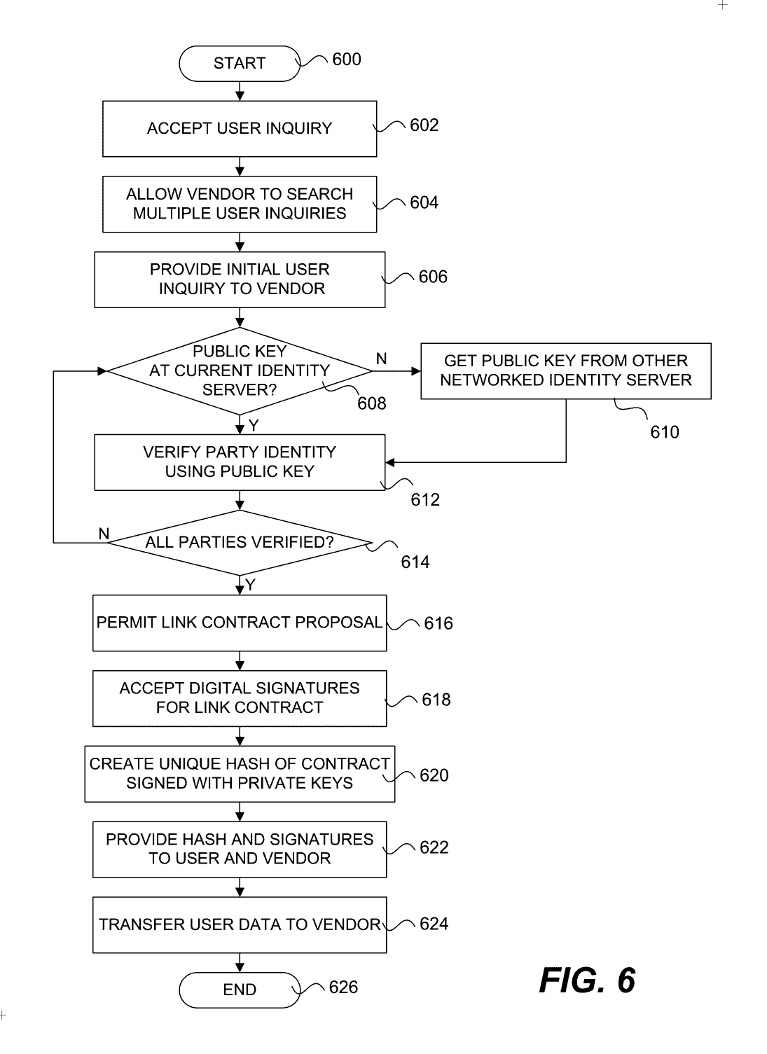

Moving lastly to FIG. 6, a flowchart of an exemplary method of protecting a data transfer on a system distributed across disparate servers or networks is provided. As in the foregoing embodiments, such a distributed system can be or form an electronic marketplace system or other similar arrangement. Although the method illustrated here for purposes of illustration involves a user and a vendor, it will be readily appreciated that other types of users or parties may also be applicable. Furthermore, more than two parties may also participate in a given transaction or process. For example, multiple users, vendors, groups, businesses, or other entities may be involved in a similar method as set forth herein. It will be understood that all such suitable variations and/or additions may also be practiced in accordance with the present disclosure.

After a start step 600, a user inquiry can be accepted at a process step 602. Again, such a user inquiry can represent an intention-casting, such as where a user expresses a general or specific interest in a particular type of product, service, activity or the like. At a following process step 604, which may be optional, a vendor can be allowed to search through multiple user inquiries, which can contain the specific user inquiry accepted in step 602. Again, the present method could also involve the use of more than one user and/or more than one vendor, as well as other types of parties.

The user inquiry accepted in step 602 can then be provided to the vendor at process step 606, upon which the vendor may then choose to act upon this particular user inquiry. A party identification verification process determines the actual identities of the user and the vendor. This verification process begins at decision step 608, where an inquiry is made as to whether a public key for the party (e.g., user or vendor) being identified is at a currently accessed public key identity server. If the key is there, then the method proceeds to process step 612. If the public key for the party at issue is not at the current public key identity server, however, then the method moves to process step 610, where the public key for the party at issue is retrieved from another public key identity server that is within a mesh network of identity servers for the present electronic marketplace system. The party at issue is then verified at the currently accessed public key identity server using its public key at process step 612. An inquiry is then made at a following decision step 614 as to whether all parties have been verified in this manner. If not, then the method reverts step 608 for the next party to be verified. If all parties have been verified using their public keys though, then the method moves to process step 616.

At process step 616, a link contract proposal can be made from one party to the other(s). Such a link contract can be a standard, partially standard, or customized contract proposing the terms under which the data transfer or porting is to be made. Again, such terms can involve what exactly can be done with the data to be transferred, which data can be protected data of the user, vendor, or both. These terms can be negotiated and/or adjusted between the parties if desired, after which digital signatures for the link contract can be accepted at a subsequent process step 618. Again, the digital signatures can include the use of the private key of each party, so as to provide proof that each party as agreed to the specific link contract at issue. A unique hash of the contract signed with the private keys of all parties can be created at process step 620, after which this unique hash and the signatures can be provided to all parties (e.g., the user and vendor) at process step 622. The data can then be transferred at subsequent process step 624. Again, such data can be personal data and/or other protected data of the user, the use of which is restricted as specified by the digitally signed linked contract. The method then ends at end step 626.

For the foregoing flowchart, it will be readily appreciated that not every method step provided is always necessary, and that further steps not set forth herein may also be included. For example, added steps to involve additional parties such as more vendors may be added, and the use of third party sites or escrow services may be added. Also, steps that provide more detail with respect to the link contract formation can also be included, such as, for example, the addition of pointers to other locations for contract provisions or terms, as well as the changing of terms. Furthermore, the exact order of steps may be altered as desired, and some steps may be performed simultaneously. For example, steps 608 through 614 may be performed before, after, or simultaneously with steps 602-606 in various embodiments. As another example, steps 618 and 620 can be performed simultaneously in some situations.

It should be understood that the devices, systems and methods described herein may be adapted and configured to function independently or may also interact with other systems or applications, such as for example, a general online sales, auction, or other marketplace. It should also be readily apparent that additional computerized or manual systems may also be employed in accordance with the disclosure in order to achieve its full implementation as a system, apparatus or method. It will be further understood that various systems, devices, components, and standards can be readily exchanged or substituted for each other where suitable. For example, any open source standard can be adapted and used with the various other components herein where suitable. As another example, HTTPS can be used in place of HTTP wherever that might be appropriate. Other examples will be readily apparent to those of skill in the art.

Those skilled in the art will readily appreciate that any of the systems and methods of the disclosure may include various computer and network related software and hardware, such as programs, operating systems, memory storage devices, data input/output devices, data processors, servers with links to data communication systems, wireless or otherwise, and data transceiving terminals, and may be a standalone device or incorporated in another platform, such as on an existing server, computing device, component or various electronic platforms. In addition, the system of the disclosure may be provided at least in part on a personal computing device, such as home computer, laptop or mobile computing device, such as a smart phone, through an online communication connection or connection with the Internet. Those skilled in the art will further appreciate that the exact types of software and hardware used are not vital to the full implementation of the methods of the disclosure so long as players and operators thereof are provided with useful access thereto for the purposes provided herein.

The various aspects, embodiments, implementations or features of the described embodiments can be used separately or in any combination. Various aspects of the described embodiments can be implemented by software, hardware or a combination of hardware and software. Computer readable medium can be any data storage device that can store data which can thereafter be read by a computer system. Examples of computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. An electronic marketplace system adapted to facilitate protected data transfers across disparate servers or networks, the electronic marketplace system comprising:
one or more communication devices adapted to facilitate digital communications to users of the electronic marketplace system; and
one or more link contract servers coupled to said one or more communication devices and a plurality of separate public key identity servers, wherein each of said one or more link contract servers is adapted to provide a link contract to a requesting user and a responding user based upon preferences of the requesting user, the responding user, or both, wherein at least one of said one or more link contract servers is adapted to provide a protected data transfer between the requesting user and the responding user after both of the requesting user and the responding user have agreed to the link contract,
and wherein the plurality of separate public key identity servers are coupled to each other, reside on separate and disparate servers or networks, and collectively contain a global last-closed ledger of public encryption keys for users of said electronic marketplace system, and wherein each of said separate public key identity servers is adapted to verify using the public encryption keys the identities of the requesting user and the responding user as part of the protected data transfer.

2. The electronic marketplace system of claim 1, wherein the link contract is communicated in an open standard format using human-readable text.

3. The electronic marketplace system of claim 2, wherein the link contract is communicated in JavaScript Object Notation (“JSON”).

4. The electronic marketplace system of claim 1, wherein the link contract is communicated by Hypertext Transfer Protocol (“HTTP”) or HTTP Secure (“HTTPS”) in an HTTP or HTTPS header.

5. The electronic marketplace system of claim 1, further including:
one or more link contract index server portions, said one or more link contract server portions having links to contracts that are similar or concern similar data, and wherein at least a portion of the link contract points to one or more link contract index server portions or third party locations that contain standard contract terms, contract portions, or entire contracts.

6. The electronic marketplace system of claim 1, wherein the protected data transfer includes personal data regarding the responding user.

7. The electronic marketplace system of claim 6, wherein the link contract includes terms that restrict the requesting user as to the specific use of the personal data regarding the responding user.

8. The electronic marketplace system of claim 1, wherein said system is adapted to accept an inquiry from the requesting user or the responding user and to provide that inquiry to other users of the system in a manner that is searchable with respect to other user inquiries.

9. The electronic marketplace system of claim 1, wherein said system is adapted to provide link contract escrow services regarding the link contract.

10. The electronic marketplace system of claim 1, further including:
the plurality of public key identity servers.

11. A method of protecting a data transfer between a user and a vendor on a system distributed across disparate servers or networks, the method comprising:
accepting an inquiry from a user at a link contract server, wherein the user inquiry indicates interest regarding information for one or more products or services;
providing the user inquiry to a vendor from the link contract server, wherein the vendor is able to provide one or more products or services relevant to the user inquiry;
verifying the identity of the vendor by using a public encryption key for the vendor at a first public key identity server selected from a plurality of public key identity servers, wherein the plurality of public key identity servers collectively contain a global last-closed ledger of public encryption keys for system users;
verifying the identity of the user by using a public encryption key for the user at the first public key identity server or a separate second public key identity server, wherein the link contract server, the first public key identity server, and the second public key identity server are all in communication with each other;
permitting either the user or the vendor to propose a link contract to the other from the link contract server in order to facilitate a data transfer between the user and the vendor, wherein the link contract contains one or more terms regarding the specific use of the data that is to be transferred;
accepting digital signatures from both of the user and the vendor at the link contract server, wherein the digital signatures indicate agreement with the terms of the link contract regarding the use of the data; and
transferring the data between the user and the vendor after the digital signatures have been accepted, wherein said transferring is facilitated by the link contract server.

12. The method of claim 11, wherein the link contract is communicated between the user and the vendor in JavaScript Object Notation (“JSON”).

13. The method of claim 11, wherein the data transfer includes personal data regarding the user, and wherein the link contract includes terms that restrict the vendor as to the specific use of the personal data regarding the user.

14. The method of claim 11, further including the step of:
creating a unique cryptographic hash of the link contract that is signed with digital signatures of both the user and the vendor using their respective private keys; and
providing a copy of the unique cryptographic hash that is signed with digital signatures to both the user and the vendor as proof of the agreed upon link contract.

15. The method of claim 11, further including the step of:
allowing the vendor to search through a plurality of inquiries on the system, wherein the plurality of inquiries includes the user inquiry.

16. The method of claim 11, further including the steps of:
searching the local ledger of public encryption keys for the public encryption key of the vendor at the first public key identity server; and
contacting one or more other servers from the plurality of public key identity servers for the public encryption key of the vendor in the event that the vendor key is not on the local ledger.

17. A computer readable medium including at least computer program code for protecting a data transfer between a user and a vendor on a system distributed across disparate networks, the computer readable medium comprising:
computer program code for accepting an inquiry from a user at a link contract server, wherein the user inquiry indicates interest regarding information for one or more products or services;
computer program code for providing the user inquiry to a vendor from the link contract server, wherein the vendor is able to provide one or more products or services relevant to the user inquiry;
computer program code for verifying the identity of the vendor by using a public encryption key for the vendor at a first public key identity server selected from a plurality of public key identity servers, wherein the plurality of public key identity servers collectively contain a global last-closed ledger of public encryption keys for system users;
computer program code for verifying the identity of the user by using a public encryption key for the user at the first public key identity server or a separate second public key identity server, wherein the link contract server, the first public key identity server, and the second public key identity server are all in communication with each other;
computer program code for permitting either the user or the vendor to propose a link contract to the other from the link contract server in order to facilitate a data transfer between the user and the vendor, wherein the link contract contains one or more terms regarding the specific use of the data that is to be transferred;
computer program code for accepting digital signatures from both the user and the vendor at the link contract server, wherein the digital signatures indicate agreement with the terms of the link contract regarding the use of the data; and
computer program code for transferring the data between the user and the vendor after the digital signatures have been accepted, wherein said transferring is facilitated by the link contract server.

18. The computer readable medium of claim 17, wherein the data transfer includes personal data regarding the user, and wherein the link contract includes terms that restrict the vendor as to the specific use of the personal data regarding the user.

19. The computer readable medium of claim 17, further comprising:
computer code for creating a unique cryptographic hash of the link contract that is signed with digital signatures of both the user and the vendor using their respective private keys; and
computer code for providing a copy of the unique cryptographic hash that is signed with digital signatures to both the user and the vendor as proof of the agreed upon link contract.

20. The computer readable medium of claim 17, further comprising:
computer program code for allowing the vendor to search through a plurality of inquiries on the system, wherein the plurality of inquiries includes the user inquiry.
